(19) United States
(12) Patent Application Publication
(10) Pub. No.: US 2006/0081391 A1
(43) Pub. Date: Apr. 20, 2006

(54) Shield used in wall surface finishing process and method

(75) Inventors: Gabriel Soussana, Las Vegas, NV (US); Moshe J. Ozeri, Victorville, CA (US)

Correspondence Address: Naomi Mann, Esq., 1509 E. McLellan Blvd., Phoenix, AZ, 85014, US

(73) Assignee: GMI

(21) Appl. No.: 10/967,888

(22) Filed: Oct. 18, 2004

(51) Int. Cl. H02G 3/14

(52) U.S. Cl. 174/66

(57) ABSTRACT

Disclosed is a shield for covering electrical outlets and switches, including their plates, during painting or other wall surface finishing process, such as plastering, priming, texturing, stucco coating, etc. The shield includes a shield encasement and a handle, which may be threadably coupled to an outer surface of the encasement. The shield may come in various sizes and shapes, based on the size and shape of the plates to be covered. The threadable handle allows the shield to be held in place with one hand, so that it covers the switch or outlet, including plate, while applying paint or other finish to the wall with the other hand, using any convenient technique such as spraying or brushing.

### BACKGROUND OF THE INVENTION

1. Field of the Invention

This invention relates generally to a tool used in painting or other wall surface finishing process, such as plastering, priming, texturing, stucco coating, etc., and more specifically to a shield for covering electrical outlets and switches including their plates during such process.

2. Description of the Related Art

Generally, the task of applying a surface finish to a wall, such as paint, involves many steps in preparing the area before the actual process. Objects which are not to be painted are typically removed or covered, for example with masking tape. Various tools have been devised by the prior art in order to address this problem. For example, U.S. Pat. No. 5,429,677, discloses a device for shielding adjacent surfaces while painting, comprising a height adjustable handle connected to a masking element by an articulating hinged element, wherein the masking element comprises a flat, rectangular guide with a series of movable fins. Additionally, U.S. Pat. No. 4,327,663, discloses a device for covering door handles during painting, composed of an elongated handle and skirt coaxially arranged and secured to one end of the handle, wherein the skirt is placed over the doorknob, so that the door may be painted without having to cover the knob with tape in order avoid painting the knob.

Preparation of all electrical switches and outlets including their plates, prior to applying a wall surface finish to a room is a particularly time consuming task. Typically, the plates of electrical switches and outlets, which are usually screwed into the wall, need to first be removed, then the switches and outlets need to be covered with tape, and finally, when the job is completed, the tape is remove and the covers are replaced. Usually, a room contains a number of electrical switches and outlets, and oftentimes, screws will be lost and plates will be broken during such process.

One example of a prior art devise for shielding cover plates for electrical outlets and switches can be found U.S. patent application publication No. 2003/0056968, which discloses a paint shield which includes a rim, deck, and raised portion on the deck to accommodate switch levers and television cable connectors, wherein adhesive is applied to areas of the under surface of the deck. Such devise is affixed around the cover plate during painting, and is likely to be difficult and time consuming to remove, especially while the paint is wet. To remedy this problem, the application disclosure provides for optionally incorporating additional features to facilitate removal, such as a perforation or zone weakness in the shape of a tab. Additionally, the required use of adhesive makes the device more difficult to reuse, since, with each use, the adhesive may become worn and in need of replacing.

What is needed is an inexpensive device for shielding electrical outlets and switches, including their plates, during painting or other room finishing process, which is quick and easy to use, and can be easily and conveniently reused with little wear.

### SUMMARY OF THE INVENTION

The present invention provides a shield for covering electrical outlets and switches, including their plates, during painting or other wall surface finishing process, such as plastering, priming, texturing, stucco coating, etc.

The shield includes a shield encasement and a handle, which may be threadably coupled to an outer surface of the encasement. The shield may come in various sizes and shapes, based on the size and shape of the plates to be covered. The shield is not adhered to the wall, but is temporarily held in place while applying paint or other finish to the wall. The threadable handle allows the shield to be held in place with one hand, so that it covers the switch or outlet, including plate, while applying paint or other finish to the wall with the other hand, using any convenient technique such as spraying or brushing. Thus, the wall may be finished quickly and conveniently without having to remove, cover, and replace any of the electrical outlets, switches, and their plates. Additionally, a single shield can be quickly and conveniently reused to cover a number of electrical switches and outlets in a single room.

### OBJECTS OF THE INVENTION

It is an object of the present invention to provide a shield for covering electrical outlets and switches, including their plates, during painting or other wall surface finishing process, such as plastering, priming, texturing, stucco coating, etc.

It is a further object of the present invention to provide such shield which comes in various sizes and shapes.

It is a further object to provide such shield which includes a handle which allows a user to hold the shield in place with one hand, while applying surface finish with the other hand.

It is a further object to provide such shield which does not have to be adhered to a wall, but is temporarily held in place while applying paint or other finish to the wall.

It is a further object to provide such shield which can be quickly and easily reused on any number of electrical outlets and switches.

It is a further object to provide a method of applying surface finish to a wall, which is quicker and more convenient than conventional methods.

It is a further object to provide such method, which does not require removing or covering any of the electrical outlet and/or switch units.

These and other objects of the present invention will become more apparent to those skilled in the art as the description of the present invention proceeds.

### BRIEF DESCRIPTION OF THE DRAWINGS

FIG. 1 is a perspective view of an electrical wall outlet and switch unit, including plate, and a shield for covering the unit, in accordance with one embodiment of the present invention.

FIG. 2 is perspective view of the shield of FIG. 1, the shield having detachable handle and encasement components, in accordance with an alternate embodiment, wherein the handle and encasement are shown detached.

FIG. 3 is a top plan view of the encasement of the Shield of FIG. 2.

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

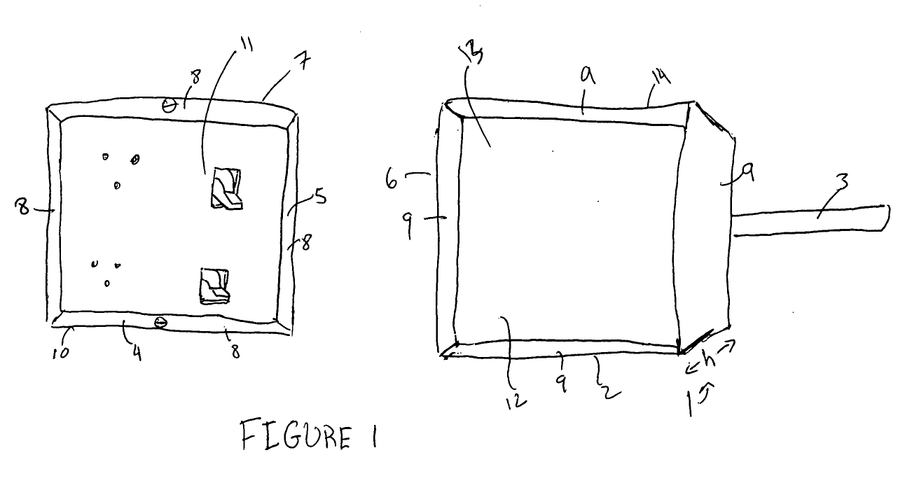

The present invention provides a shield 1, comprising a shield encasement 2, and handle 3. The shield 1 is used for covering an electrical wall outlet and/or switch unit, such as the unit 4 illustrated in FIG. 1, during painting or other wall surface finishing process, such as plastering, priming, texturing, stucco coating, etc. A typical outlet and/or switch unit may include any number of switches, outlets, or a combination thereof, housed by a cover plate 5, as illustrated in the figure. The shield 1 can be used for covering any number of electrical units of similar size and shape during a single job.

Encasement 2 may come in a variety of sizes and shapes to fit any type of electrical outlet and/or switch unit, including plate. Most cover plates for such units typically come in standard sizes and shapes, including a flat rectangular or square surface 11 (i.e. 4½×2¾, 4½×4½, 4½×6 5/16, 4½×8 1/16, and 4½×10 inches), with downwardly extending walls 8, which may be curved or angled, and with the bottom edges of walls 8 forming a rectangular or square peripheral edge 10 abutting the surface of a wall where the plate is installed to cover a switch and/or outlet unit. Such plates may also be irregularly shaped, or include different designs deviating from the standard size and/or shapes for aesthetics.

Encasement 2 includes a top surface 12, and downwardly extending walls 9, defining an encasement cavity 13, with the bottom edges of walls 9 forming a peripheral edge 14. The encasement 2 may be made of plastic, metal, cardboard, wood, or other suitable material, and may come in a variety of sizes to accommodate standard sized, and even non-standard and uniquely designed plates.

Encasement cavity 13 is designed large enough so that it may easily fit over the electrical outlet/switch unit to be covered, with the peripheral edge 14 capable of being pressed against the wall surface surrounding the unit. Preferably, the height (h) of encasement 2 is designed to accommodate the height of a standard lever-type switch, which is higher than an outlet, and may also be higher to accommodate electrical timers or other such installations. As such, a shield for covering either an outlet or switch unit, or a unit including both, can be sized based on the plate size, regardless of whether the plate is for an outlet or switch unit, as shown in FIG. 1.

Top surface 12 of the encasement is preferably flat, but may also include elevated and/or depressed portions generally based on the elevated and depressed portion of the outlet/switch unit.

The walls 9 of the encasement may be curved or straight, and may extend from top surface 12 at any desired angle, including 90° or greater, as illustrated in the figures, based on design preference. In order to minimize the amount of area around plate 5 which is left unpainted, the perimeter of peripheral edge 14 is preferably sized slightly larger than the perimeter of peripheral edge 10, such that the walls 9 of the encasement closely surround walls 8 of the plate. To this end, walls 9 are made as thin as possible, with the preferred thickness being less than approximately 5 mm.

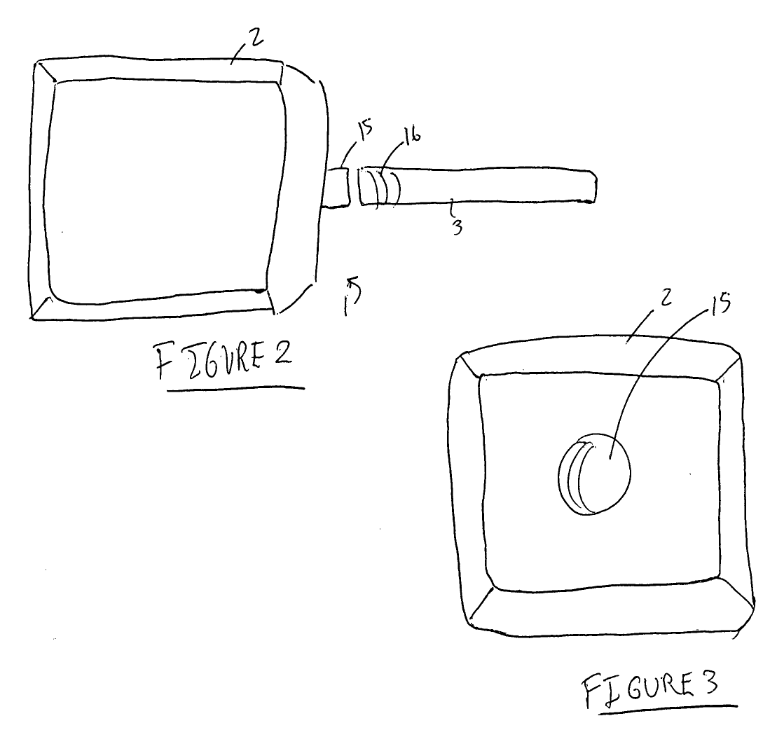

The handle 3 may be formed integral with the encasement 2, or releasably coupled therewith. FIGS. 2 and 3 illustrate a shield having a handle with a threaded male end 16 which may be connected to a receiving female threaded member 15 on an outer side of the surface 12. The receiving female end may alternatively be on the handle, with the male end on the encasement. Other ways of releasably coupling the encasement and handle will be apparent to one skilled in the art. This enables one handle to be used with a variety of encasements, which are differently sized to fit over a variety of wall plates. Thus, a shield kit may be sold in a package including one handle and a plurality of differently sized encasements, which may be coupled to the handle. The handle may be formed from wood, metal, plastic, or any other rigid material, and is preferably at least 3 inches long, and more preferably between 8 and 20 inches long, such that the user may hold the shield via the handle far enough away from the wall, and apply the finish material, without getting it on his/her hand.

Thus, in applying finish to a wall surface, a user may simply hold an appropriately sized shield over the electrical switch and/or outlet unit with one hand, in order to temporarily encapsulate the unit, while applying the finish material around the unit with the other hand. The same shield can then be removed and reused on a different unit of the same size. Thus, using the shield of the present invention, including shields having different sized encasements if necessary, a paint or other finish job may be completed quickly and conveniently without having to remove or mask a single outlet/switch cover plate. This invention further contemplates shields designed to cover other fixtures built into the wall, such as ceiling lights.

While the present invention has been described with regards to particular embodiments, it is recognized that additional variations of the present invention may be devised without departing from the inventive concept.

1-6. (canceled)

7. A shield for covering an electrical plate during a wall surface finishing process, the shield comprising:
an encasement adapted for covering said electrical plate, said encasement having a top surface and side walls forming an inner cavity to encapsulate the electrical plate; and
a handle having a first end attached to said encasement, on a side opposite said inner cavity, and a second opposing end, said handle being at least 3 inches long from said first to said second end, said handle being releasably coupled to said encasement, said encasement fitting snuggly over said plate, wherein the plate is mounted on the wall.

8. A shield for covering an electrical plate during a wall surface finishing process, the shield comprising:
an encasement adapted for covering said electrical plate, said encasement having a top surface and side walls forming an inner cavity to encapsulate the electrical plate; and
a handle having a first end attached to said encasement, on a side opposite said inner cavity, and a second opposing end, said handle being at least 3 inches long from said first to said second end, said handle being releasably and threadbaly coupled to said encasement said encasement fitting snuggly over said plate, wherein the plate is mounted on the wall.

9.-11. (canceled)
